(19) United States
(12) Patent Application Publication
(10) Pub. No.: US 2006/0111886 A1
(43) Pub. Date: May 25, 2006

(54) Method and system for modeling of a differential bus device

(76) Inventor: Mahesh Siddappa, Santa Clara, CA (US)

Correspondence Address: SAWYER LAW GROUP LLP, P O BOX 51418, PALO ALTO, CA, 94303, US

(21) Appl. No.: 10/996,640

(22) Filed: Nov. 23, 2004

(51) Int. Cl. G06F 13/10

(52) U.S. Cl. 703/21

(57) ABSTRACT

Aspects of efficient modeling of a differential bus device in an ASIC library include utilizing a hardware description language (HDL) to model a differential bus device. A mapping scheme based on signal strengths of the HDL is utilized to represent a set of differential bus signals as single bits during simulation of the differential bus device. Further, the differential bus device comprises a USB device, and the HDL comprises Verilog.

### FIELD OF THE INVENTION

The present invention relates to differential bus device modeling, and more particularly to efficient Universal Serial Bus (USB) cell modeling.

### BACKGROUND OF THE INVENTION

Simulations play a vital part in the verification stages of integrated circuit development, especially in the case of customized application specific integrated circuits (ASICs), which are designed and brought to market rapidly. Simulation and verification tools are critical to the ASIC development cycle, and other such system development cycles. Hence, an ASIC design is not considered complete until it has been thoroughly simulated and its functionality completely verified.

ASICs are typically designed using some form of HDL (Hardware Description Language), such as VHDL, Verilog, or the like. The functionality and features of an ASIC design are typically embodied as a behavioral model, which describes the behavior of the ASIC. Verification at this stage is done by simulating the ASIC as defined by its behavioral model. The ASIC design is then synthesized using synthesis tools to specific target-libraries, which transform this “behavior” into a “netlist” represented by logic gates in that target-library. Verification at this stage is done by simulating the ASIC as defined by its netlist.

During the verification process, sophisticated simulation algorithms are used to verify the functional blocks of the ASIC. Thus, a simulator applies test stimuli to a device model at specified times and observes the responses of the model to the stimuli. These responses are often recorded and printed out for the ASIC designer as output wave forms. The responses, or test results, are interpreted by the designer to verify whether or not the design of an ASIC is satisfactory.

Such simulation techniques are used for the design and development of USB (Universal Serial Bus) devices. The USB specification is an industry-defined interface for connecting peripherals to the system bus of a personal computer. USB features a single interface for a wide variety of peripherals, including mice, keyboards, monitors, printers, mass storage devices, modems, faxes, and the like. This reduces manufacturing costs and makes it easier for personal computer users to configure their systems. A first generation USB standard (version 1.1) allows transmissions in two modes, a low speed (1.5 megabits per second (Mbps)) and a full speed (12 Mbps) mode. A newer USB standard (version 2.0) additionally allows a third (high speed, 480 Mbps) transmission mode.

An example of a USB simulation environment 100 is shown in FIG. 1. The environment 100 (e.g., the ATUSBTEST-SS7400 from Atmel Corporation of San Jose, Calif.) is designed to simulate and verify the application and USB functionality during the initial phases of the design and to verify the complete application in the final stages of the design. As shown, the environment 100 includes typical functional blocks of: a host bus functional model 110 to generate USB traffic; a monitor model 120 within host bus model 110 to monitor USB traffic; a target device core 130; and an end application model 140 to emulate the end application. The host bus functional model 110 further includes a host command file interface 150, while the end application model 140 includes an application command interface 160. The application model 140 handles control transfers, interrupt transfers, bulk/ISO in and bulk/ISO out transfers. The application command file interface 160 is used to transfer the required data and provide simple controls to generate commands from the application model 140.

Of concern when performing USB device simulations are the USB signals. The USB signals are differential, and the USB specification supports different voltage levels. It is difficult to model the voltage levels in the ASIC library, since there is no standard on how to do it.

The common and obvious way to represent the USB 2.0 differential bus is to make the bus into a wider bus, e.g., the two differential bus signals can be represented by four wires, thus allowing the encoding of up to 16 different USB states. Tables are required to describe how the levels have been encoded in the model. This makes it difficult to select the correct strengths to make it work in all the different USB modes of suspend, resume, bus reset, chirping, and speed detection. Further, it is not intuitive to look at buses and decode them while viewing them on a computer screen and also think of what is happening on the bus during a simulation and debug session.

Accordingly, a need exists for an efficient and effective approach for USB bus representation for modeling of USB cells for an ASIC library. The present invention meets this need.

### BRIEF SUMMARY OF THE INVENTION

Aspects of efficient modeling of a differential bus device in an ASIC library are described. The aspects include utilizing a hardware description language (HDL) to model a differential bus device. A mapping scheme based on signal strengths of the HDL is utilized to represent a set of differential bus signals as single bits during simulation of the differential bus device. In a further aspect, the differential bus device comprises a USB device and the HDL comprises Verilog.

Through the present invention, the mapping scheme allows the user of the USB model to simply define wires and connect them for ASIC development. In this manner, there is no need for a user to define a bus, the connections are simple, waveform diagram results are easy to read and understand, and there are no conversions. These and other advantages of the aspects of the present invention will be more fully understood in conjunction with the following detailed description and accompanying drawings.

### BRIEF DESCRIPTION OF SEVERAL VIEWS OF THE DRAWINGS

FIG. 1 illustrates a block diagram representation of a prior art USB test environment.

FIG. 2 illustrates a block diagram of a portion of a simulation environment in accordance with the present invention.

FIG. 3 illustrates a table for a voltage level mapping scheme in accordance with the present invention.

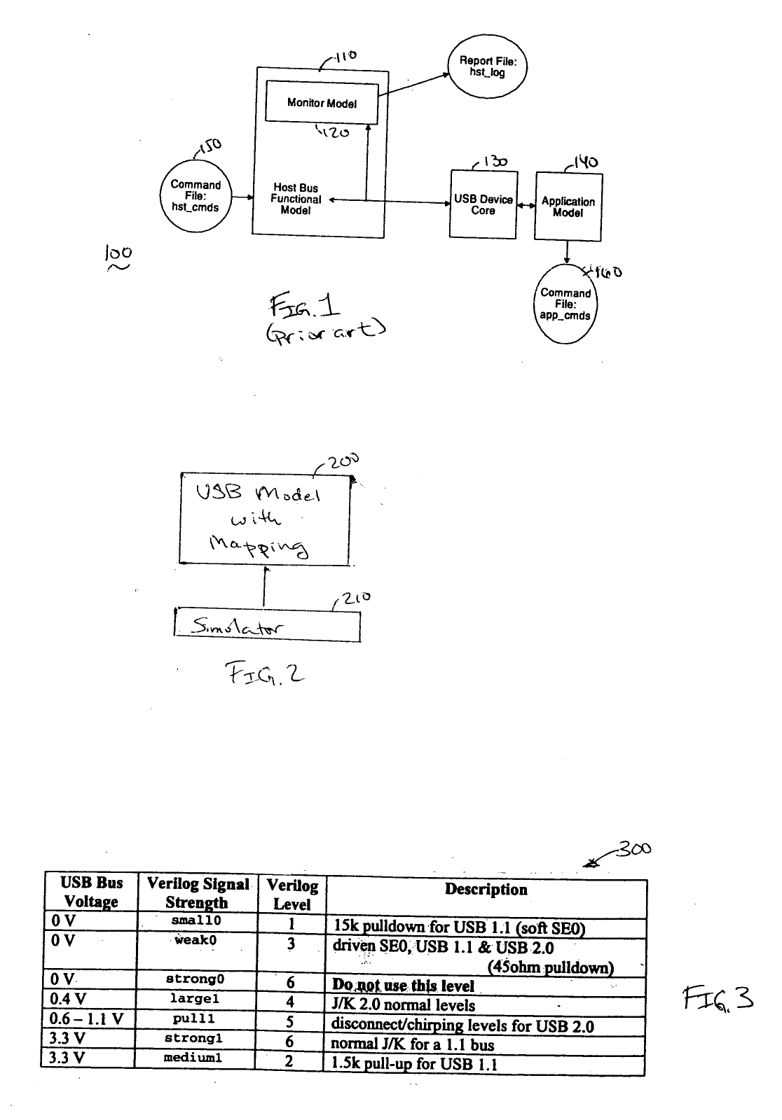

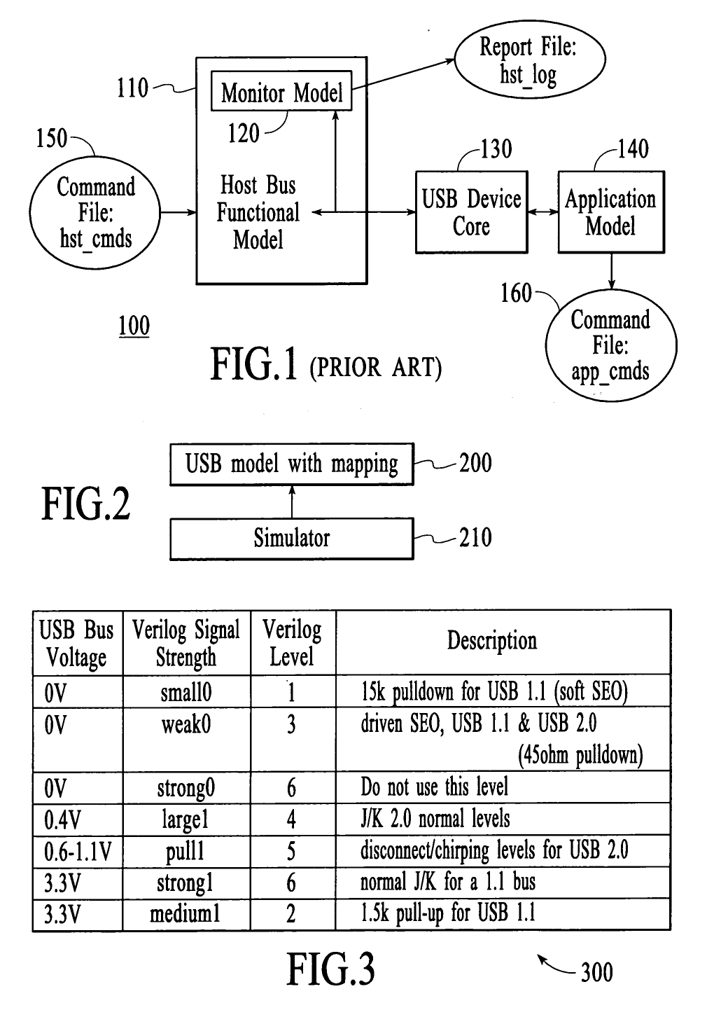

### DETAILED DESCRIPTION OF THE INVENTION

The present invention relates to differential bus device modeling. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

In accordance with the present invention, a mapping scheme is introduced that keeps the differential USB bus wires as single bits. FIG. 2 illustrates a block diagram of a portion of a simulation environment in accordance with the present invention. As shown, the environment includes a USB model with mapping 200 that is embodied as HDL code in Verilog to model the behavior, functionality, and features of a USB device. (e.g. a host USB device or simulation environment made up of different USB devices). Model 200 runs on top of simulator 210. Simulator 210 applies test stimuli to a device model at specified times and observes the responses of the model to the stimuli, which are often recorded as output wave forms, as is well understood in the art.

In a preferred embodiment, the USB model with mapping 200 employs a scheme by which signal strengths of the HDL are used to represent the set of differential bus signals. That is, the Verilog signal strengths are mapped to USB bus voltage levels in the USB model 200 to keep the USB wires as single bits during the simulation. FIG. 3 illustrates a table 300 of the mapping.

In the mapping shown by the table 300 of FIG. 3, pulldown and pullup signals are represented with weaker signal strengths to allow driving signals to override them. A pullup signal is slightly stronger than a pulldown signal to reflect the behavior of the resistors used on the USB bus. The signaling levels are assigned increasing values of strength to match their relative voltage level and relative electrical behavior of the USB bus. SE0 (single-ended zero) for both USB 1.1 and USB 2.0 is represented by weak0. This allows the USB 1.1 drivers to provide the terminations to the bus for USB 2.0 signalling and can be overridden by all driven USB 2.0 signals during signalling. This SE0 level will also override all of the pullup levels. The default value of strong1 is used for a driven logic 1 in USB 1.1 signalling. The USB 2.0 signalling levels are assigned according to relative voltage levels on the bus and are all weaker in strength than the USB 1.1 J/K levels.

It should be appreciated that the strong0 signal strength level is shown and should not be used. Also, pullup and pulldown resistors use trireg nets to generate their signals and not the normally used pullup and pulldown Verilog sources, as is well understood by those skilled in the art. Further, the squelch signal (100 millivolts) is intended to be an internal signal of a high speed transceiver and is not explicitly represented in the model.

By way of example, when there are four USB I/O (input/output) pins per port in a USB transceiver, definition of “wires in verilog” to represent the USB signals and the connections to the USB module inout pins can be done by:
wire dp, dm;
//INOUT
.dm (dm),
.dp(dp),
.hsdm (dm),
.hsdp (dp),

The Verilog model of the USB pads use different Verilog strengths to model the USB states according to the termination and tranceiver control inputs of the transceiver macrocell. The signal strength mapping is as shown in FIG. 3. It is recommended that the same USB I/O model is used in the host or stimulus environment also.

Thus, the mapping scheme of the present invention allows the user of the USB model to simply define wires and connect them for ASIC development. In this manner, there is no need for a user to define a bus, the connections are simple, diagram results are easy to read and understand, and there are no conversions.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

We Claim:

1. A method for efficient modeling of a differential bus device in an ASIC library, the method comprising:
utilizing a hardware description language (HDL) to model a differential bus device; and
utilizing a mapping scheme based on signal strengths of the HDL to represent a set of differential bus signals as single bits during simulation of the differential bus device.

2. The method of claim 1 wherein utilizing a mapping scheme further comprises mapping voltage levels of the set of differential bus signals to the signal strengths.

3. The method of claim 2 wherein utilizing a hardware description language further comprises utilizing Verilog to model a bus device.

4. The method of claim 3 wherein the bus device further comprises a Universal Serial Bus (USB) device.

5. The method of claim 4 wherein the signal strengths further comprise six signal strengths.

6. The method of claim 5 wherein the six signal strengths further comprise small, medium, weak, large, pull, and strong.

7. A system for efficient modeling of a differential bus device in an ASIC library, the system comprising:
a bus device model of a bus device, the bus device model written in a hardware description language (HDL) and utilizing a mapping scheme based on signal strengths of the HDL to represent a set of differential bus signals; and
a simulator for simulating performance of the bus device model, wherein the set of differential bus signals are represented as single bits.

8. The system of claim 7 wherein the mapping scheme further comprises a mapping of voltage levels of the set of differential bus signals to the signal strengths.

9. The system of claim 8 wherein a hardware description language further comprises Verilog.

10. The system of claim 9 wherein the bus device model further comprises a Universal Serial Bus (USB) device model.

11. The system of claim 10 wherein the signal strengths further comprise six signal strengths.

12. The system of claim 11 wherein the six signal strengths further comprise small, medium, weak, large, pull, and strong.

13. A method for more efficient Universal Serial Bus (USB) cell modeling in an ASIC library, the method comprising:
defining a correlation between voltage levels specified for a USB bus and signal strengths of a hardware description language (HDL); and
utilizing the correlation when modeling a USB device by the HDL, wherein definition of the USB bus as two single bit wires occurs during modeling.

14. The method of claim 13 wherein defining a correlation further comprises mapping voltage levels specified for the USB bus to Verilog signal strengths.

15. The method of claim 14 further comprising mapping the voltage levels to six signal strengths.

16. The method of claim 15 wherein the signal strengths further comprise small, medium, weak, large, pull, and strong.
